(19) United States
(12) Patent Application Publication
(10) Pub. No.: US 2017/0124289 A1
(43) Pub. Date: May 4, 2017

(54) System for Coordinating Medical Treatments and In-Care Patient Tracking

(71) Applicants: Muhammad Ali Hasan, Huntington Beach, CA (US); David MacLeod, Denver, CO (US); Ben Williams, Littleton, CO (US)

(72) Inventors: Muhammad Ali Hasan, Huntington Beach, CA (US); David MacLeod, Denver, CO (US); Ben Williams, Littleton, CO (US)

(21) Appl. No.: 15/371,740

(22) Filed: Dec. 7, 2016

Related U.S. Application Data
(60) Provisional application No. 62/250,358, filed on Nov. 3, 2015.

(51) Int. Cl. G06F 19/00; G06Q 10/08

(52) U.S. Cl. CPC G06F 19/3481; G06F 19/345; G06F 19/322; G06Q 10/087

(57) ABSTRACT

A method for coordinating medical treatments and in-care patient tracking system is set forth wherein a patient peripheral enables determination of patient location data, patient identification data, and treatment data, by sensed spatiotemporal relationships of the patient peripheral within a designated area. Proximity of the patient peripheral with a practitioner peripheral enables automated association of treatment data to a patient record alongside practitioner identification data. Treatment data generated, such as collected samples and other data, effects automatic assignment of the patient identity to relevant data and materials. Inventory is trackable, and doses administered are reportable automatically to the patient record.

### CROSS-REFERENCE TO RELATED APPLICATIONS

This nonprovisional application claims the priority of provisional application No. 62/264,589 filed on Dec. 8, 2015.

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### TO ALL WHOM IT MAY CONCERN

Be it known that we, Muhammad Ali Hasan, David Macleod, and Ben Williams, all citizens of the United States, have invented new and useful improvements in a system for coordinating medical treatments and in-care patient tracking as described in this specification and that this nonprovisional application clams the benefit of provisional application No. 62/264,589 filed on Dec. 8, 2012.

### COPYRIGHT NOTICE

Some portions of the disclosure of this patent document may contain material subject to copyright protection. The copyright owner has no objection to the facsimile reproduction by anyone of the patent document or ensuing disclosure as it appears on record at the Patent and Trademark Office, but otherwise reserves all copyright rights whatsoever.

### BACKGROUND OF THE INVENTION

Various types of methods for coordinating medical treatments and in-care patient tracking systems are known in the prior art. However, what is needed is a system for coordinating medical treatments and in-care patient tracking that includes at least one base station disposed in wireless coverage over a designated area wherein patient identification data, patient location data, time of entry data, time of exit data, and treatment data are deteminable by wireless communication with a patient peripheral device sensed operating within the designated area, and wherein a practitioner peripheral device likewise communicates practitioner identification data and practitioner location data to effect automated updating of a patient record accessible over network through a central server.

Inventory control and management is effective by integration with the present system, whereby weight adjustments sensed in packaging of reagents, medicines, and other inventory items, as said inventory is dispensed, communicates weight data to the central server whereby inventory data is generable indicative of remaining stock and to quantity dispensed. Doeses of particular medicaments administered by particular personnel is trackable and updateable to the patient record. Further, samples collected from the patient and data generated during treatment of the patient, are automatically associable to the patient record and, where relevant, thereby trackable and monitorable by the present system within and between designated areas.

### FIELD OF THE INVENTION

The present invention relates to a system for coordinating medical treatments and in-care patient tracking, and more particularly, to a system for coordinating medical treatments and in-care patient tracking that includes at least one base station disposed in wireless coverage over a designated area wherein patient and practitioner peripherals enable determination of identification data, location data, time of entry data, time of exit data, and treatment data administered within the designated area.

A patient peripheral, ported on or by a patient seeking medical care, enables communication of associated patient identification data when said patient peripheral is sensed within the designated area. Time of entry data may be recorded and a matched medical appointment verified by networked communication with a central server. Movement of the patient peripheral about the designated area, or between designated areas within a medical establishment or compound, enables updated patient location data whereby particular treatments peculiar to certain designated areas may be communicable to the patient record. Thus, for example, arrival of a particular patient at a medical establishment may be verified and movement of the patient peripheral to a particular location within the medical establishment, for example an x-ray room, may signal particular treatment, in this instance an x-ray, was administered. Additional patient location data indicative of treatment data is contemplated as part of this invention, as set forth hereinbelow.

Further, practitioner peripherals ported on or by medical professionals or other caregivers signal practitioner identification data and location data to be associated with particular patient identification data, when said practitioner peripheral is sensed most proximal a patient peripheral. Thus a particular careegiver or practitioner may be associated as providing particular care determinable from the patient identification data, patient location data, practitioner identification data, practitioner location data, and any particular treatment data as may be signaled from specific treatment options and/or apparatuses provided in particular designated areas or by particular medical devices, medicines, or hardware. Particularly, doses of treatments and duration of treatments are articulable to the patient record by means of the present systems and method, as set forth hereinbelow, whereby coordinated care is trackable and recordable for a particular patient undergoing treatment within a particular designated area.

Inventory control is provided by wireless communication of inventory data to the at least one base station from storage facilities and locations. Inventory data includes weight data of inventory placed upon weight-sensitive storage media whereby changes in weight of particular inventory receptacles are wirelessly communicable to the at least one base station and updateable to the central server and an inventory management system. Unit weights of particular inventory are predetermined, and adjusted weight data is thereby indicative of precise quantities of inventory dispensed, whereby a known to volume (and/or dose) of any particular inventory item dispensed is trackable and current inventory levels are thereby immediately determinable. Such inventory data is thus matchable with treatment data across patient records to conflate quantities dispensed with treatments administered.

### SUMMARY OF THE INVENTION

The present system for coordinating medical treatments and in-care patient tracking has been devised to enable automated updates to a patient record by wireless communication effective between a patient peripheral and at least one base station disposed having wireless coverage over designated areas of a medical establishment, whereby patient movements between designated areas signal updates to the patient record, and a patient identity, medical practitioner or caregiver identity, time of entry, time of exit, and any treatments administered, may be automated to the particular patient's record.

The term “peripheral”, as used herein throughout, is taken to include any such peripheral device able to remain sensible to at least one base station to wirelessly signal specific location data, time data, and an associated identification data whereby a particular person, patient, practitioner, object, apparatus, location, or treatment, is identifiable in space and time. Examples of peripheral devices contemplated as part of this invention include smart phones, handhelds, tablets, computing devices, radio frequency identification tags (“RFID” tags), magnets, electromagnetic oscillators, or any combination therebetween, among other such peripheral devices rendered sensible in space and time within a designated area and operable in wireless communication with at least one base station emitting frequencies of electromagnetic radiation.

At least one base station, therefore, is disposed in wireless coverage over a designated area. When a patient peripheral is sensed within the designated area the base station effects an automated update of patient identification data and patient location data to a patient record accessible over network with a central server. The base station may be sensible of specific and particular location data associated with each designated area, whereby patient location data may determine a particular treatment data by virtue of the sensed location of the patient. Thus patient arrival at a particular medical practitioner office, for example, may signal patient identification data, time of entry data, and update the patient record to confirm a scheduled appointment has been fulfilled. Movement of the patient through the particular medical establishment may further signal updates to the patient record, such as, for example, when receiving an x-ray (or other procedure or treatment) requiring physical location of the patient at a particular designated area whereby treatment data is determinable.

Additionally, the caregiver, medical practitioner, or other medical professional, as case may be, may be associated with the patient record as giving particular care or conducting particular procedures by sensed proximity of a practitioner peripheral to the patient peripheral or by virtue of position determined by relevant practitioner location data. Thus practitioner identification data may be automatically updated to the patient record as the patient receives scheduled and/or particular care.

Furthermore, peripheral devices are contemplated associated with particular medicines, medicaments, or other treatments, whether medical devices or substances, administrable when providing care. A syringe used for intravenous injection, for example, may include peripherals associated with the plunger and each gradation disposed upon the syringe whereby drawing of the syringe enables sensing of the plunger position relative each gradation. A volume drawn is thereby sensible, and a dose may be articulated and updated to the patient record. Peripherals herein contemplated may include RFID tags or magnetic elements, among other such peripherals, whereby movement of the plunger effects generation, or alteration, in a sensible electromagnetic, electric, or magnetic field, whereby position of the plunger, for example, relative each gradation indicative of volume upon the syringe is determinable. Particular medicines may likewise include a peripheral rendering such medicine sensible to the at least one base station, whereby a particular medicine may be determined as provided to the patient from patient location data and associated treatment data.

Location of the practitioner peripheral relative a peripheral associated with a particular medicine or treatment (such “treatment” including, for example, medical devices) may associate practitioner identification data with a particular treatment data. Proximity of a patient peripheral to a peripheral associated with a particular medicine or treatment (including medical devices) may therefore communicate treatment data to the patient record. Dosages administered are therefore communicable and a patient record may be updated automatically with relevant treatment data.

Medicines and dosages administered may include pills, liquids, and other medicines, as well as treatments from particular medical devices. Pills and liquids may be sensed at a point of measurement—for example a practitioner may count out pills to a scale, for example, or other station associated with a base station, whereby the quantity of a determined medicine may be communicated (by weight, for example, as applied to a known unit weight associated with the particular medicine encoded as part of the treatment data). Administration of that medicine to a particular patient may therefore be associated with the practitioner identification data and patient identification data and a determined dose of a particular treatment data may be recorded and tracked. Likewise, treatments requiring an exposure time may similarly enable calculation of a dose or treatment duration determined from patient proximity to the particular treatment and determination relative a time of entry data and a time of exit data.

Further, in like manner as discussed hereinabove, data generated when treating a patient (such as an x-ray image, for example) or samples collected (such as blood drawn, for example) may be automatically associated with the patient identification data based on spatiotemporal relationships of the patient peripheral determined relative apparatuses, locations, and practitioner peripherals, for example, and in like manner associated to the patient record and tracked within, and between, designated areas. Thus treatment data generated by treating a patient is automatically controlled, coordinated, and tracked by the present system.

The present system for coordinating medical treatments and in-care patient tracking, therefore, enables automated tracking of patient and practitioner interactions and enables automated updating of a patient record with relevant and pertinent information whereby patient identification data is associable with patient location data and treatment data, as administered or provided in particular designated areas. Practitioner identification data is likewise determinable and the provision of care to a particular patient is thereby monitorable, trackable, verifiable, and recordable.

Inventory of medicines, reagents, medicaments, and other items storable as inventory in medical facilities, is controllable, trackable, and monitorable by integration with the present system. Inventory is stored in receptacles of known weight, and positioned upon weight sensitive storage media. Exact weight of inventory, tared to control for receptacles, is thereby generable; said inventory weight data wirelessly communicable to the at least one base station. All controlled substances are thereby trackable from storage, to quantity dispensed, and matchable with patient treatment data whereby use of all inventory is verifiable across patient records.

As inventory is dispensed from storage, changes in inventory weight data are communicable to the base station and thus to the central server where a quantity of dispensed inventory is determinable and a remaining inventory thereby configurable, whereby remaining inventory stock is displayable for inventory management and control.

The quantity of inventory dispensed is readily matchable with treatment data across patient records for any particular time period desired, whereby dispensation of inventory for particular treatments is verifiable. Further, storage areas may be determined as designated areas wherein entry thereto communicates identification data and time of entry data to the base station for monitoring over an inventory management system. Subsequent dispensation of particular medicines, reagents, or other inventory items, is then associable with the sensed identification data until a time of exit data is received and the particular identity has vacated the storage area. Identification data may be generated biometrically in some instances, wherein physical characteristics are required to verify practitioner identification data.

Thus has been broadly outlined the more important features of the present method for coordinating medical treatments and in-care patient tracking system so that the detailed description thereof that follows may be better understood and in order that the present contribution to the art may be better appreciated.

For better understanding of the method for coordinating medical treatments and in-care patient tracking system, its operating advantages and specific objects attained by its uses, refer to the accompanying drawings and description.

### BRIEF DESCRIPTION OF THE DRAWINGS

### Figures

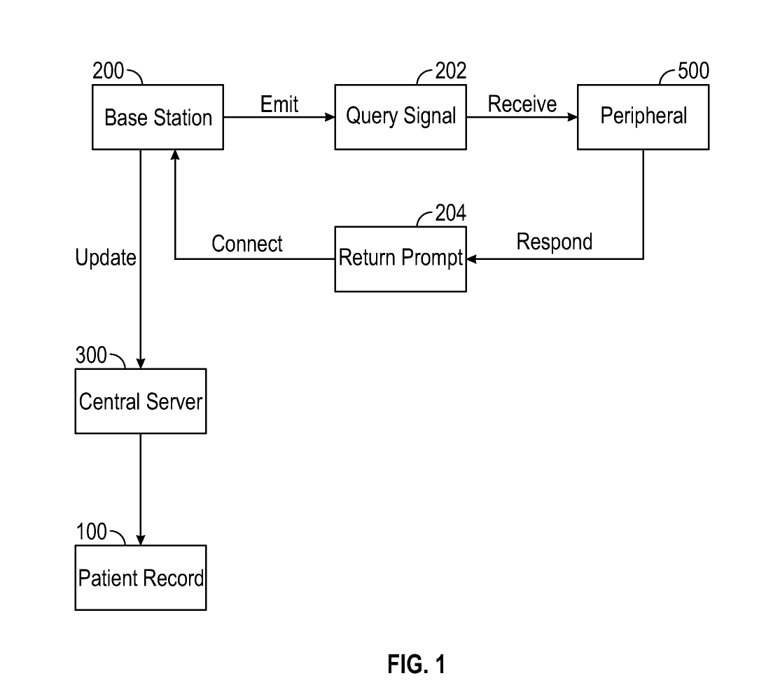

FIG. 1 is a diagrammatic view of an example embodiment of wireless connection established between at least one base station and a peripheral device to effect update of a patient record.

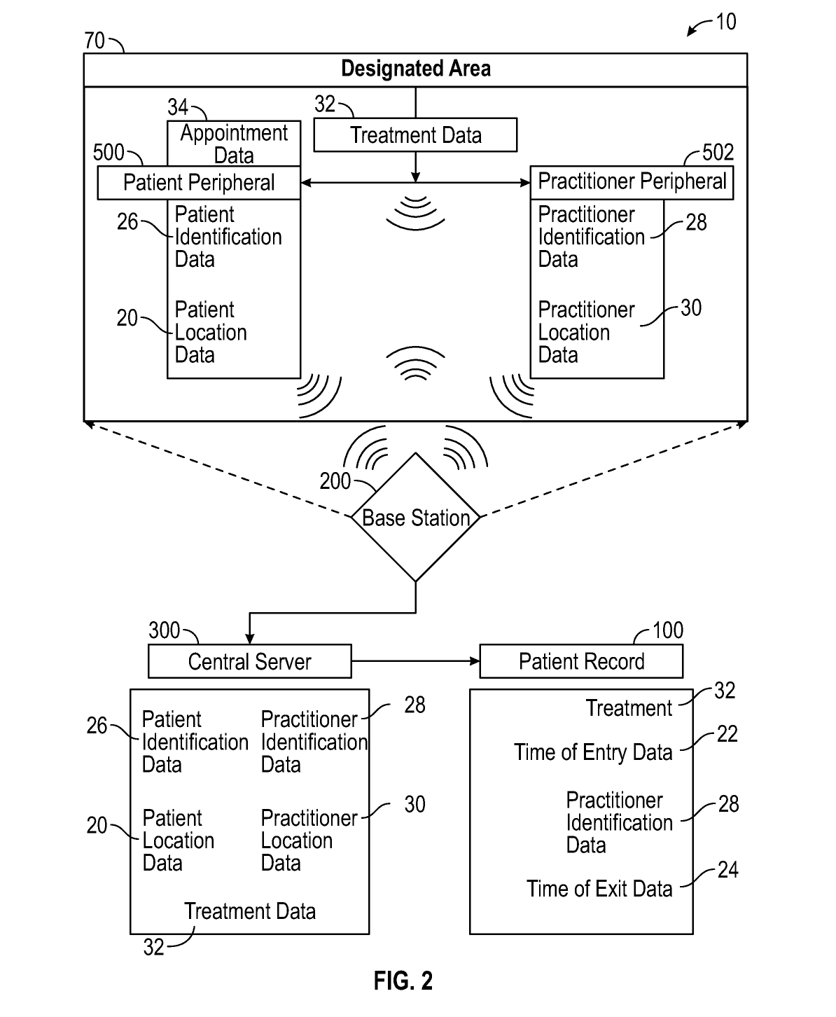

FIG. 2 is a diagrammatic view of an example embodiment of the method for coordinating medical treatments and in-care patient tracking system.

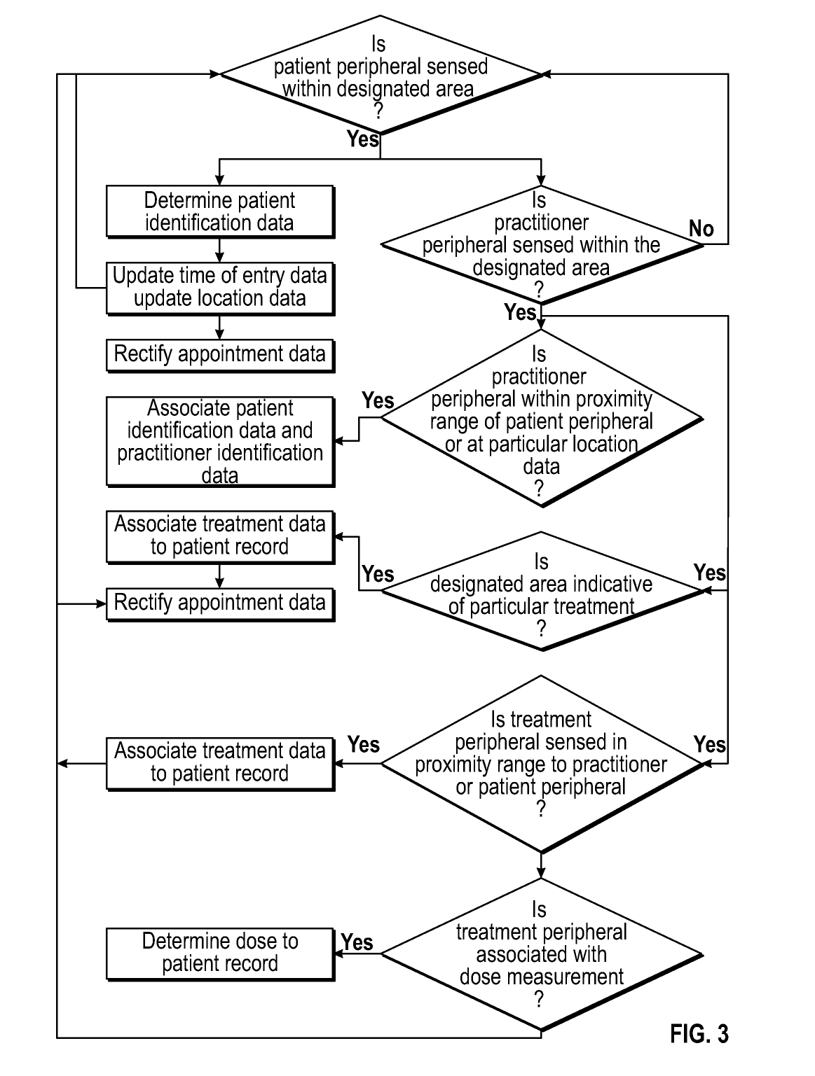

FIG. 3 is a flow diagram of an example embodiment of the present method for coordinating medical treatments and in-care patient tracking system.

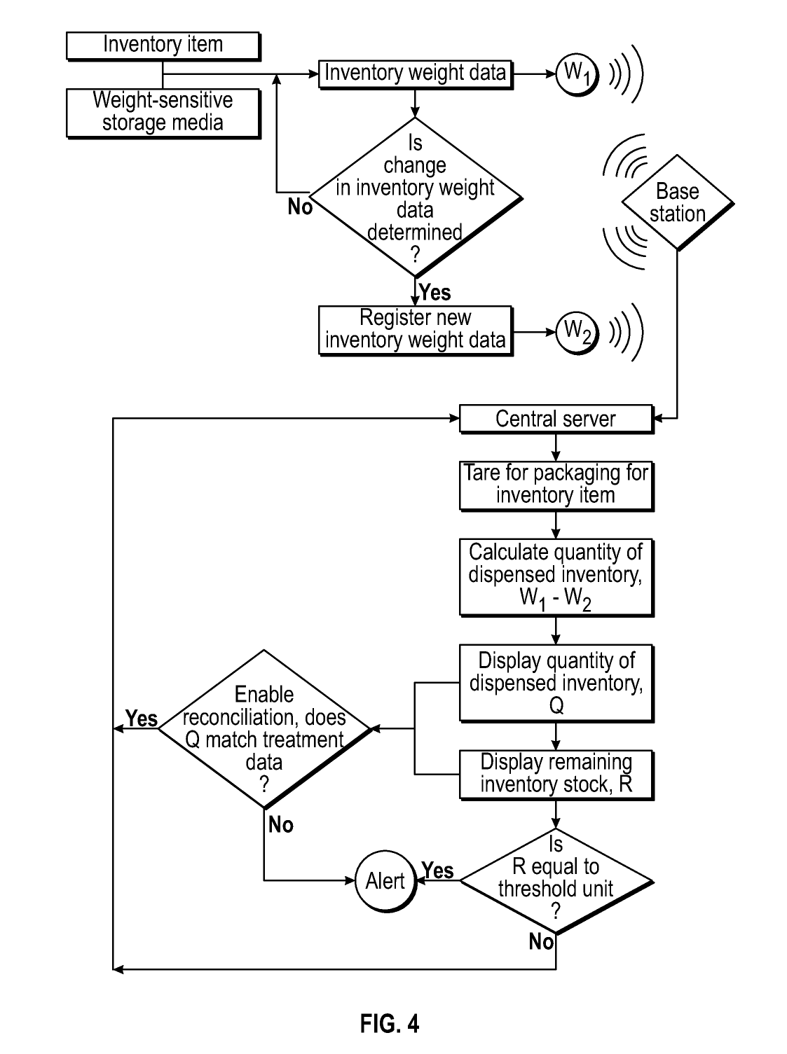

FIG. 4 is a diagrammatic view of an example embodiment of inventory management and control associated with the present method for coordinating medical treatments and in-care patient tracking system.

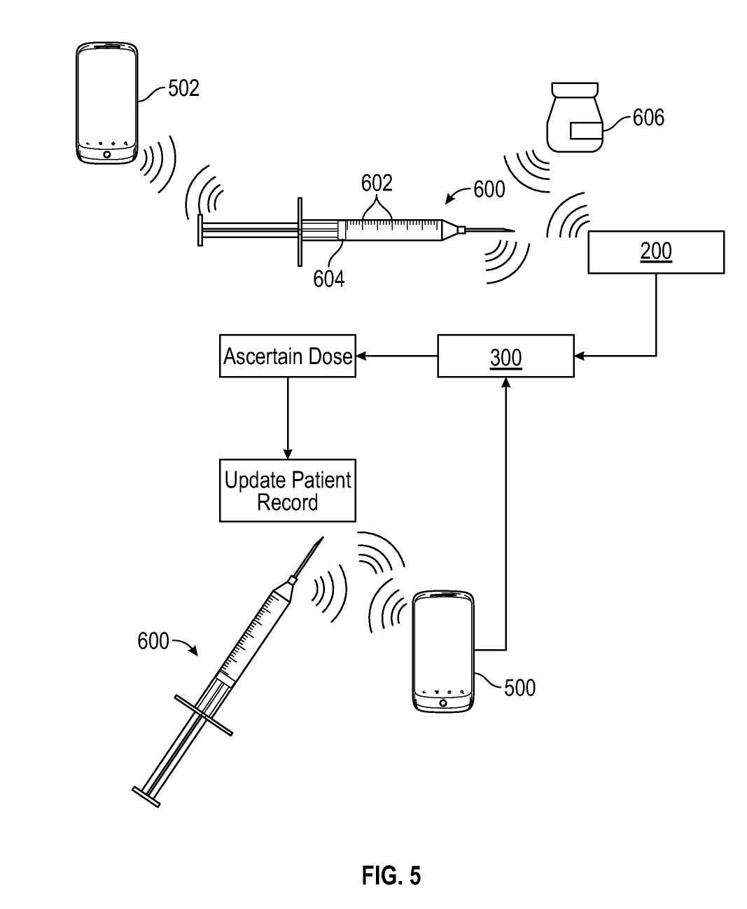

FIG. 5 is a flow diagrammatic view of an example embodiment of a dose generation for update of a treatment data associated with a patient record.

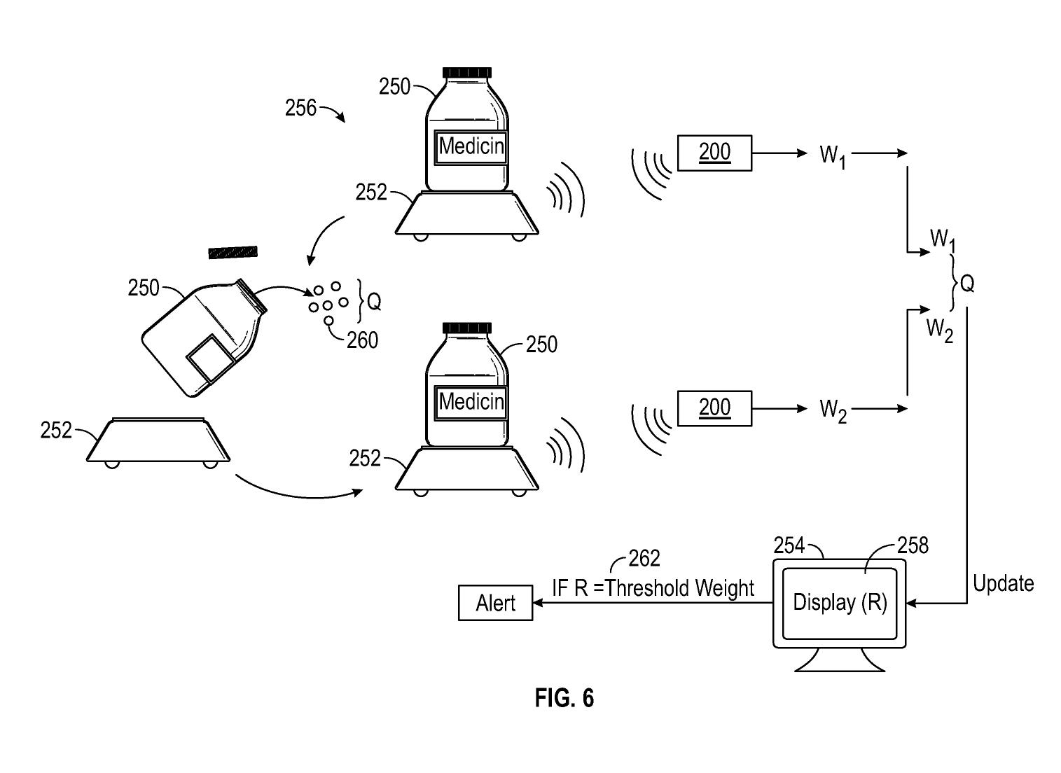

FIG. 6 is a flow diagrammatic view of an example embodiment of the inventory management system.

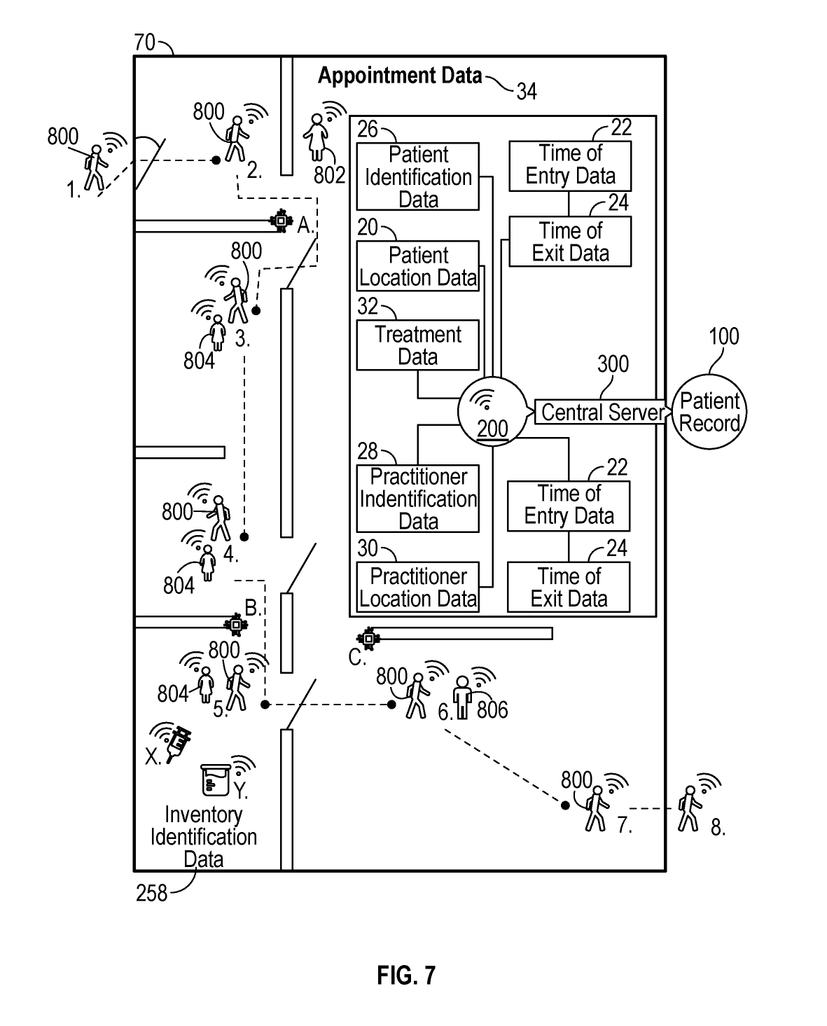

FIG. 7 is a diagrammatic view of an example implementation of the present method for coordinating medical treatments and in-care patient tracking system.

### DETAILED DESCRIPTION OF THE DRAWINGS

With reference now to FIGS. 1 through 7, example of the instant method for coordinating medical treatments and in-care patient tracking system employing the principles and concepts of the present method for coordinating medical treatments and in-care patient tracking system will be described.

Referring to FIGS. 1 through 7, an example embodiment of the method for coordinating medical treatments and in-care patient tracking system 10 is illustrated.

The present method for coordinating medical treatments and in-care patient tracking system 10 has been devised to assist automation of tracking patients and effecting patient intake at a particular medical establishment, treatment facility, or doctor's office by wireless communication between a patient peripheral device 500 and at least one base station 200 disposed in a requisite location wherein medical treatments are provided. The present method for coordinating medical treatments and in-care patient tracking system 10, therefore, enables confirmation of patient arrival, confirmation of patient appointment, confirmation of particular patient treatment by a particular caregiver or caregivers, confirmation of a patient's doctor or medical professional, and prescription and dosage management when treatments are administered. Furthermore, the present method for coordinating medical treatments and in-care patient tracking 10 enables automated association of samples taken, and procedures performed, to particular patient records whereby update of a patient record is automated by proximity determination of wirelessly sensible peripheral devices, as will be explained hereinbelow.

The present method for coordinating medical treatments and in-care patient tracking 10, therefore, senses proximity of a patient peripheral 500 to at least one base station 200 operative in a medical establishment whereby the patient's identity is ascertainable as captured patient identification data 26. The at least one base station 200 thus emits a query signal 202 at regular intervals, and either detects the presence of a passive peripheral device 500 (such as an RFID tag, for example, or other sensible passive oscillator resonant in wireless communications) to which the patient identity has been previously assigned, or alternatively a peripheral device 500 in possession of the patient responds to the query signal 202 and delivers a return prompt 204 wherein connection is effected (see FIGS. 1 and 2). In the latter case, connection is determined by relevant data transmitted between the peripheral device 500 and the base station 200. Once connection is established, and the patient identity ascertained, the base station 200 effects communication with a central server 300 to record arrival of the patient at the particular medical establishment or designated area 70 wherein the patient peripheral 500 is rendered sensible (“patient location data” 20). The time of the patient's arrival is logged in a patient record (“time of entry data” 22), and appointment schedule for the particular patient is verified wherein a patient arrival for a particular scheduled appointment is verified in the patient record 100 (“appointment data” 34).

In the case of a passive peripheral device in use associated with a particular patient (or medical practitioner or inventory item as case may be), the at least one base station 200 recognizes the presence of the passive peripheral device within a designated area 70 and associates that presence to access and update a unique patient record 100 administered by a central server 300. In either event, time of entry data 22, time of exit data 24, patient identification data 26, practitioner identification data 28, patient location data 20, practitioner location data 30, and treatment data 32, among other data as set forth herein, are updateable to the patient record 100 by sensed position of the patient peripheral 500 determined active within a particular designated area 70 and/or in proximity to a relevant practitioner peripheral 502 and/or particular apparatus whereby treatment is administrable.

Patient arrival may be signaled by proximity of a patient peripheral device 500 rendered sensible to the base station 200 or at patient check-in by display and scan of an optical code generable on-screen of the patient peripheral 500. Patient identification data may be verified physically in-person by a practitioner present to confirm or authenticate patient identity. Appointment data 34 previously entered into the system may rectify time of entry data 22 to the particular appointment data 34 and thereby determine the purpose of the patient visit.

Patient waiting time to see a medical practitioner may be articulated from returned prompts 204 emitted by the peripheral 500 while waiting in a designated area 70, and time seen by any particular medical practitioner may be recordable by passage of the patient most proximal a particular barrier or threshold 72 whereby the patient record 100 is updatable by movement of the patient between specific locations defined within a medical establishment. Moreover, proximity of a patient peripheral 500 sensed relative a practitioner peripheral 502 may associate identification data of a particular patient and a particular medical practitioner, as case may be, and write said data to the patient record 100.

Medial practitioners may wear or carry a peripheral device 502 indicative of, or associated with, their identity whereby any medical practitioner is identifiable as treating any particular patient verifiable by proximity relationship in space and time. Thus passage of a medical practitioner into or out of a designated area 70 in proximity to a particular patient may associate that practitioner and patient on the patient record 100 (see for example FIG. 7). In some instances, proximity between a patient and a practitioner may be required to remain within a certain distance over a certain period of time in order for the practitioner to be designated as providing care, treatment, or escorting a patient between designated areas, to obviate confusion as may otherwise arise when multiple practitioners and patients are determined to be within a common place (such as a corridor or hallway, for example). However, designated areas 70 are contemplated to include definite thresholds 72, such as doorways and partitioned private spaces wherein particular patient care is provided and, in some cases, exclusively provided, whereby particular treatments are determinable as specific treatment data 32 to the patient record 100 by virtue of the patient occupying a ii particular location within the designated area 70 (see, for example, 5 in FIG. 7).

In most cases, designated areas 70 definitive of patient and practitioner movements, are defined by, and communicable at, certain boundaries and thresholds 72 to avoid confusion between multiple practitioners and patients in a single place, said designated areas 70 delimited, for example, at thresholds between waiting areas and treatment centers and/or treatment locations (such as, for example, an X-Ray room, and MRI, a dentist's chair, for example), thresholds into particular rooms, or a patient's overnight room in a hospital, say. Thus entry into a particular room or location for treatment, for example, may signal a practitioner identity data 28 and time of entry data 22 to the patient record 100. A patient identification data 26, time of entry data 22, location data 20, practitioner identity data 28, time of exit data 24, and treatment data 32, may all be updated to the patient record 100 and reconciled with existing appointment data 34 maintained on record automatically and generated by movement of practitioners and patients relative one another within the designated area 70.

Furthermore, administration of medicines, associated dosages, and samples collected are trackable by the present system 10 (see FIGS. 5 and 7, for example). Referring to FIG. 5 by way of example, syringes 600 (or other apparatus, such as Intravenous Therapy) may include peripherals 500, such as, for example, RFID tags associated in this example with the plunger 604 and with each gradation 602 disposed upon the syringe 600 appropriate for monitoring a volumetrically devised dose. Drawing the syringe 600, therefore, may effect activation of dose monitoring whereby passage of the plunger 604 passed each peripheral disposed upon each of the gradations 602 situated upon the syringe 600, for example, may communicate a volume to the central server 300.

Depression of the plunger 604 thereafter may subsequently transmit the volume injected into a patient whereby a dose is ascertainable. Furthermore, peripherals 500 associated with particular medicines may enable determination of the particular medicament 606 drawn into the syringe 600 (or other delivery apparatus), said medicament 606 associated with the syringe 600 by closest proximity of said syringe 600 with the medicament 606 at time of dose generation and capture. The syringe 600 may be activated for discovery by the base station 300 by removal from packaging or by manual engagement of a particular action, such as, for example, fitting the needle or, alternately, placing the needle through the seal of a medicine container to draw medicament 606 therefrom. Thus doses of particular medicaments 606 injected into a patient are trackable and updateable to the patient record 100. Further, the practitioner identity administering the treatment is likewise updateable to the patient record 100 as practitioner identity data 28, along with the time of the treatment and the location where the treatment was effected.

The dose may likewise be communicable by use of magnetic elements associated with each gradation 602 on the syringe 600, in this example, such as magnetic paint or other magnetic particles, able to generate sensible changes to an electromagnetic field producible when the plunger 604 is moved therethrough. Movement of the plunger 604 passed each gradation 602 may therefore generate an electric field, or flux, whereby the volume drawn and the volume injected are communicable to the base station 200. The exact dose, therefore, or a particular medicament 606 is thereby writable to the patient record 100.

Additional means of determining relevant treatment data 32 are contemplated as part of this invention 10, such as communication of a weighed quantity, duration of a particular treatment administered, time and place of treatment or practitioner and patient, or by other means generable by position or movement of treatment options and objects within the designated area 70. Further, collection of samples from patients is likewise associable with patient identification data 26 and inventory identification data 258 is assignable to receptacles having peripherals associated therewith whereby treatment data 32 is assignable to a particular patient identification data 26 and recordable upon the patient record 100 automatically. Such samples are thereby trackable as inventory within the designated area 70 and between designated areas 70, as case may be. Further, metadata may signal to a patient record 100 fulfillment of appointment data 34 such as, for example, when a procedure is performed, for example, said procedure may be communicated to the central server 300 to include a metadata ID code which is verifiable and rectifiable with the appointment data 34 entered. For example, a particular appointment may be entered as appointment data 34 whereby a numerical or alphanumeric family of codes is warranted as fulfillment for said appointment. For example an x-ray, say, might include the metadata ID prefix of X010. Wherein x-rays performed my signal the type of x-ray and enable fulfillment of the appointment, such as, for example, X012, in this example communicating an x-ray of the patient left femur was completed whereby the appointment data 34 is verified and the appointment designated as fulfilled upon the patient record. Additional families and species of metadata codes are contemplated for communicating fulfillment of particular appointment data 34.

Thus positions of patients, medical practitioners, and inventory in particular places throughout a medical establishment are rendered communicable to at least one base station 200 whereby patient movements, treatments, and caregivers are trackable, recordable, assignable and a patient record 100 is automatically updateable.

Inventory management and control is contemplated as part of the present method for coordinating medical treatments and in-care patient tracking system 10, as shown in FIG. 4 and FIG. 6. Inventory in any medical establishment includes controlled substances, restricted items, bio-hazard, and tissue samples, among other inventory. The present method 10 enables constant monitoring of inventory 250 to determine a quantity of inventory dispensed (Q) and, concurrently, remaining stock of each and all inventory items (R). Inventory is storable upon weight sensitive storage media 252 whereby dispensation of inventory 250 registers a change of inventory weight data (W₁-W₂) for any particular item 250. Inventory weight data (W₁ and W₂) is wirelessly communicable to the at least one base station 200 whereby a quantity of inventory dispensed (Q) is articulable. Remaining inventory stock (R) is likewise configurable for display through an inventory management system 254 disposed in networked communication with the at least one base station 200.

Furthermore, inventory storage areas may be designated areas 70 whereby identification data 28, time of entry data 22, and time of exit data 24, associate particular persons entering the storage area with any inventory recorded as dispensed between the relevant time of entry data 22 and the time of exit data 24. Thus inventory 250 is monitorable, trackable, and dispensation of inventory is verifiable across associated identification data 28.

Each inventory item 250 is identified in the central server 300 by means of the inventory weight data (W₁ and W₂). Inventory weight data (W₁ and W₂) is contemplated to include inventory location data 256 and inventory identification data 258. Inventory identification data 258 enables computation of Q as packaging weight may be subtracted from inventory weight data (to record a tared weight, for example) whereby quantities dispensed are thence divisible by an inventory unit weight 260 whereby a dose or other quantity is articulable, specific for particular inventory identification data 258. Thus liquids, powders, pills, among other medicines, reagents, and other inventory items, are trackable by dispensation of quantities articulable as units or doses when divided by the inventory unit weight 260.

Rectification of inventory 250 dispensed is enabled with treatment data 32 recorded across the system, whereby Q is matchable with treatment data 32 to verify use of inventory 250 dispensed. Remaining stock (R), may be configured to display an alert for any particular inventory item 250 reaching a predetermined threshold weight 262 whereby replacement of the inventory item 250 may soon be required.

Referring now to FIG. 7, an example embodiment of the present method for coordinating medical treatments and in-care patient tracking systems 10 is illustrated by scenario. Patient 800 arrives at the boundary of the designated area 70 at 1. Patient 800 enters the designated area 70 generating patient identification data 26, patient location data 20, and time of entry data 22 by action of the patient peripheral 500 wirelessly communicating with the at least one base station 200. Patient 800 signs in at 2 whereat practitioner 802 practitioner identification data 28 is associated with patient identification data 26 to update the patient record 100 in real time. In this example, practitioner 802 is office personnel responsible for verifying the physical identity of patient 800 (and thereby matching and verifying physical identity with the patient identification data) and confirming appointment data 34. Patient 800 then travels passed threshold A, logging patient location data 20 and time of exit data 24 from the reception area into area designated by threshold A. Patient 800 is guided by practitioner 804 to room designated by threshold B. wherein practitioner 804 performs phlebotomy using syringe X which associates patient identification data with vial Y containing patent 800's blood. Vial Y is now trackable in the system. The patient record 100 automatically updates to reflect treatment data 32 comprising, in this example, practitioner 804 practitioner identification data 28, treatment performed (and volume of blood drawn in this example) and inventory identification data 258 assigned to vial Y now associated with patient 800. Patient appointment data 34 is reconciled.

Patient 800 exits to threshold C whereat practitioner 806 performs further treatment at 6. Patient 800 patient record 100 is resultantly updated to reflect treatment data 32 generated by interaction with practitioner 806. Patient then exits designated area 70 at 7 and leaves scope of the at least one base station 200. Time of exit data 24 is recorded to patient 800's patient record 100. Should patient cross into another designated area, for example in an adjacent treatment facility, time of entry data 22 and patient identification data 26 is written to the patient record 100 whereby patient movement and treatment data 32 are trackable.

The example scenario illustrated in FIG. 7 provides an overall illustration of the power of the present method and system. The example could equally be applicable, for example, in a dentist's office, wherein treatment data 32 collected at 5, rather than phlebotomy and associated drawn samples as inventory, an X-ray could have been performed. In such a scenario, the X-ray may be associated to the patient record 100 by patient location data 30 associated at an X-ray apparatus, and practitioner identification data 28 could be associated to the patient record 100 by practitioner location data 30 determining practitioner location as in a specific location (s.a. for example on the other side of a radiation controlled wall). Treatment performed at 6 in this scenario could be, for example, a cleaning, wherein the hygienist is associated with the patient. Treatment performed to generate particular treatment data 32 is controllable by practitioner identification data and practitioner location data. Thus, should a filling be performed, for example, appointment data 34 on the patient record (wherein a filling was scheduled) is rectifiable with practitioner location data—in this instance a dentist and an assistant, for example, cohabiting the same space and time in conjunction with a patient exemplifying particular and specific patient identification data and patient identification data, such as, for example, said patient determined to be seated in a particular dentist's chair in close proximity to said dentist and assistant for an appropriate length of time as logged by time of entry and time of exit data.

Additional examples of applications of the present method for coordinating medical treatments and in-care patient tracking system 10 should be readily ascertainable by one having ordinary skill in the art, the above example scenarios provided illustrative of particular implementations of the instant system, the full scope and power of which enables automated tracking of patients receiving medical care in any particular treatment center.

What is claimed is:

1. A system for coordinating medical treatments and in-care patient tracking within determined bounds of a designated area, said system comprising:
at least one base station disposed wirelessly sensible of said designated area, said base station disposed to effect wireless communications with each of a patient peripheral and a practitioner peripheral when discovered as operating within the bounds of said designated area;
at least one threshold disposed within the bounds of the designated area, said at least one threshold enabling communication of time of entry data and time of exit data whenever the patient peripheral or the practitioner peripheral is sensed at said at least one threshold;
wherein patient identification data is readable from the patient peripheral and transmissible to a central server to enable update of a patient record;
wherein patient location data is readable from the patient peripheral and transmissible to the central server to enable update of the patient record determinable relative space and time within the designated area;
wherein practitioner location data is readable from the practitioner peripheral and transmissible to the central server to enable update of the patient record proximally determined in space and time relative the patient peripheral and space and time within the designated area;
wherein practitioner identification data, readable from the practitioner peripheral, is transmissible to the central server and associable with the patient record when said practitioner peripheral is discovered within a proximal range of the patient peripheral;
wherein practitioner identification data and patient identification data enable determination of treatment data updateable to the patient record; and
wherein patient location data enables determination of treatment data updateable to the patient record.

2. The system for coordinating medical treatments and in-care patient tracking of claim 1 further comprising at least one peripheral device disposed associated with a medical device, said at least one peripheral device communicating use of said medical device in treating a patient when the patient peripheral is determined to be within a proximal range of the at least one peripheral device and whereby practitioner identity, determinable by proximity to the said at least one peripheral, is associable to the patient record generable as treatment data.

3. The system for coordinating medical treatments and in-care patient tracking of claim 1 further comprising at least one peripheral device disposed associated with a medicament, said at least one peripheral device disposed in wireless communication with the central server, whereby dispensation of the medicament is recordable and a quantity dispensed is updateable to the patient record.

4. The system for coordinating medical treatments and in-care patient tracking of claim 2 wherein the at least one peripheral device disposed associated with a medical device communicates dose as part of treatment data associable to the patient record.

5. The system for coordinating medical treatments and in-care patient tracking of claim 3 wherein the at least one peripheral device disposed associated with a medicament is associable with an inventory weight data in storage whereby a change in weight registered to the inventory weight data enables computation of a quantity of inventory dispensed.

6. The system for coordinating medical treatments and in-care patient tracking of claim 4 wherein the at least one peripheral device comprises at least one gradation and a plunger of a syringe whereby movement of the plunger passed the gradation signals a volume drawn into the syringe whereby the dose of the medicament drawn is computable and associable to the patient record.

7. The system for coordinating medical treatments and in-care patient tracking of claim 5 wherein proximity of the practitioner peripheral relative the at least one peripheral device disposed associated with a medicament in space and time associates practitioner identification data with the quantity of inventory dispensed.

8. The system for coordinating medical treatments and in-care patient tracking of claim 5 wherein inventory weight data includes a threshold weight whereby an alert is displayed when said inventory weight data reaches the threshold weight.

9. A system for coordinating medical treatments and in-care patient tracking within determined bounds of a designated area, said system comprising:
at least one base station disposed wirelessly sensible of said designated area, said base station disposed to effect wireless communications with each of a patient peripheral and a practitioner peripheral discovered as operating within the bounds of said designated area;
at least one peripheral associated with at least one medicament, said at least one peripheral discoverable to the at least one base station whereby inventory identification data is determinable;
at least one threshold disposed within the bounds of the designated area, said at least one threshold enabling communication of time of entry data and time of exit data whenever the patient peripheral or the practitioner peripheral is sensed at said at least one threshold;
wherein patient identification data is readable from the patient peripheral and transmissible to a central server to enable update of a patient record;
wherein patient location data is readable from the patient peripheral and transmissible to the central server to enable update of the patient record;
wherein practitioner location data is readable from the practitioner peripheral and transmissible to the central server to enable update of the patient record;
wherein practitioner identification data, readable from the practitioner peripheral, is transmissible to the central server and associable with the patient record when said practitioner peripheral is discovered within a proximal range of the patient peripheral;
wherein proximity between the practitioner peripheral, the patient peripheral, and the at least one medicament, enables determination of treatment data updateable to the patient record;
wherein practitioner identification data and patient identification data enables determination of treatment data updateable to the patient record; and
wherein patient location data enables determination of treatment data updateable to the patient record.

10. A system for coordinating medical treatments and in-care patient tracking comprising:
at least one base station wirelessly sensible of a designated area;
at least one threshold disposed with the designated area, said at least one threshold communicable with the at least one base station and determinative of a particular location within the designated area;
a central server disposed in operational communication with the at least one base station;
a patient peripheral disposed wirelessly communicable with the at least one base station, said patient peripheral discoverable by the at least one base station when sensed present within the designated area, said patient peripheral devised to:
communicate patient identification data to the at least one base station, said patient identification data associable with previously entered appointment data and a specific patient record, said patient record thereby updateable by communication with the central server;
communicate patient location data when the patient peripheral is discovered operating within the designated area, or within a proximal range of the at least one threshold, said patient location data updateable to the patient record;
communicate time of entry data when the patient peripheral is first discovered within the designated area and whenever the patient peripheral is first discovered at the at least one threshold, said time of entry data updateable to the patient record;
communicate time of exit data when the patient peripheral is last discovered within the designated area and when the patient peripheral is discovered away from the at least one threshold subsequent relay of time of entry data specific thereto, said time of exit data updateable to the patient record;
a practitioner peripheral disposed wirelessly communicable with the at least one base station, said patient peripheral discoverable by the at least one base station when sensed present within the designated area, said practitioner peripheral devised to:
communicate practitioner identification data to the at least one base station;
communicate practitioner location data when the practitioner peripheral is discovered operating within the designated area, at the at least one threshold, and when proximal a peripheral associated with a particular medicament or apparatus;
communicate time of entry data when the practitioner peripheral is first discovered within the designated area and whenever the practitioner peripheral is first discovered at the at least one threshold;
communicate time of exit data when the practitioner peripheral is last discovered within the designated area and when the practitioner peripheral is discovered away from the at least one threshold subsequent relay of time of entry data specific thereto;
wherein practitioner identification data and patient identification data enable communication of treatment data updateable to the patient record by spatiotemporal relationships of the patient peripheral and practitioner peripheral operating in space and time within the designated area; and
wherein said treatment data is rectifiable with the appointment data and treatment, practitioner, and patient are associable automatically to the patient record in real time.
